(19) United States
(12) Patent Application Publication
(10) Pub. No.: US 2006/0033293 A1
(43) Pub. Date: Feb. 16, 2006

(54) Sixth gear

(76) Inventor: Raiden John Tsuboi, Moraga, CA (US)

Correspondence Address: Raiden John Tsuboi, 4 Corliss Dr., Moraga, CA, 94556, US

(21) Appl. No.: 11/205,581

(22) Filed: Aug. 16, 2005

Related U.S. Application Data
(60) Provisional application No. 60/601,714, filed on Aug. 16, 2004.

(51) Int. Cl. B62B 15/00

(52) U.S. Cl. 280/14.24

(57) ABSTRACT

A snowboard binding baseplate, adjustable without tools, for quickly changing the location and angular orientation of snowboard bindings. Recessions in the baseplate accommodate a plurality of lever driven cam lock assemblies. These cam lock assemblies each drive a machine screw anchored in the snowboard. When all the lever assemblies are in the open position, slack is created between the baseplate, boot binding and snowboard. One can then adjust the rotational and longitudinal orientation of the boot bindings with respect to the snowboard. All of the moving parts are internal to the baseplate and binding assembly to discourage snow accumulation and eventual jamming. Baseplate dimensions can be tailored to fit different manufacturer's stock bindings.

### CROSS-REFERENCE TO RELATED APPLICATIONS

This application claims the benefit of PPA Ser. No. 60/601,714 filed Aug. 16, 2004, by the present inventors.

### FEDERALLY FUNDED RESEARCH

not applicable

### SEQUENCE LISTING OR PROGRAM

not applicable

### BACKGROUND OF THE INVENTION—FIELD OF INVENTION

This invention relates to snowboarding, specifically to the attachment of the boot bindings to the snowboard.

### BACKGROUND OF INVENTION—PRIOR ART

In the mother of all board sports, surfing, a rider can move their feet freely on the surfboard to excel in different wave conditions and styles. In the sport of snowboarding, which is remarkably similar to surfing, foot positioning, or one's stance, is determined by the location of the boot bindings with respect to the board. Ideally, one would have adjustable bindings, in order to change stance, to best suit the present snow conditions and desired riding style. Previous attempts to make snowboard bindings on-the-fly (without tools) adjustable have taken different forms. Achieving rotational adjustment was solved often by using a system of interlocking plates. These disc like plates, numbering two or more, would engage and disengage by the turning or pulling of levers. Many systems require a complete new binding apparatus, instead of providing parts to retrofit existing, stock bindings. The remaining systems work with stock bindings, but raise the stack height or ride height of the bindings on the board, which is not ideal. Further, many systems incorporate essential parts to the design on the exterior of the boot bindings, inviting clogging of moving parts with errant snow. The various embodiments by Acuna, in U.S. Pat. No. 5,984,325, should be noted for developing a system that could fit stock bindings and may not increase the ride height of the bindings. The work by Acuna adequately addresses rotational adjustability in a number of embodiments, but does not allow for the adjustment of fore-aft positioning. Unfortunately, these embodiments also require key pieces to be external to the bindings. Snowboarding technology must function after snow deposits on or between moving parts. Thus, a system internal to the bindings and shielded from the elements is advantageous. Rotational adjustment is key in dictating riding style. Equally important is the fore and aft positioning of the bindings if one is to excel in different snow conditions. The present invention works with stock bindings, maintains ride height, and allows for on-the-fly rotational and fore-aft adjustment with all moving parts internal to the bindings.

### BACKGROUND OF INVENTION—OBJECTS AND ADVANTAGES

Several objects and advantages exist in the invention. One object is that it provides on-the-fly adjustability to bindings. This adjustability takes the form of rotational adjustment as well as fore and aft adjustment. Another object it accomplishes is working with stock binding systems. Furthermore, it does not have to change the ride height of the stock bindings. This invention will also allow for adjustment of both bindings individually, granting many stance variations.

The advantages include the ability to tailor the dimensions of the invention to fit different manufacturer's bindings. Also, fore-aft adjustability, in addition to rotational adjustability, is addressed. The adjustability is accomplished with fewer springs and small parts than its predecessors. Only one disc, in the form of a baseplate, is used for simplicity. The invention can be manufactured from am array of materials. Further, all parts of the invention are internal and guarded from snow.

Further objects and advantages of my invention will become apparent from a consideration of the drawings and ensuing description.

### SUMMARY

Snowboarding and surfing are sports that can be performed in a variety of styles, depending on the natural conditions of the moment. As water conditions change, a surfer will move the orientation of their feet, with respect to the board, to better distribute their weight. The same response to changing snow conditions would require a snowboarder to possess bindings adjustable in both rotational and fore-aft capacities, while maintaining operation in the unique presence of snow.

The industry standard for fastening strapped bindings to boards utilizes a central baseplate. This widely popular method uses machine screws and washers, fastened to the snowboard. Tightening or loosening the screws vertically engages or disengages gear teeth in the upper baseplate with corresponding teeth in the lower binding apparatus. Adjusting such baseplates, and subsequently the bindings, requires work with a screwdriver and is time consuming.

In the preferred embodiment of the invention, a customized baseplate will house recessed cam locks, one for each screw. The cam locks manipulate the pressure of the screw on the baseplate, binding apparatus, and snowboard. The cam locks are engaged by levers accessible to one's hands. In the closed or locked position, the levers lie recessed, horizontal in the baseplate. When opened, by rotating the levers toward vertical, the force holding down the baseplate lessens. This lessens the force on the binding as well. As the cams are distanced from the baseplate, the baseplate is allowed it to pop up vertically, with the help of a spring. This upward movement of the baseplate disengages the gear teeth in the baseplate from the gear teeth in the binding apparatus. Once the gear teeth are disengaged, the binding apparatus can be rotated as well as moved fore or aft.

All parts of the invention can me manufactured from metals in a CNC machining process. Also, other composite materials can be used.

### DRAWINGS—FIGURES

FIG. 1 represents a perspective view of the invention, affixing of snowboard bindings to the snowboard through a custom baseplate and lever assembly.

FIG. 2 is an exploded view of the invention, one binding assembly, and the snowboard.

FIG. 3 is an overhead view of the invention with all lever assemblies with a closed or locked status.

FIG. 4 is a cross-section view of one lever assembly in a locked position.

FIG. 5 is a cross-section view of one lever assembly in an open position.

FIG. 6 is a view of the baseplate only

FIG. 7 is a view of one lever assembly

### DETAILED DESCRIPTION

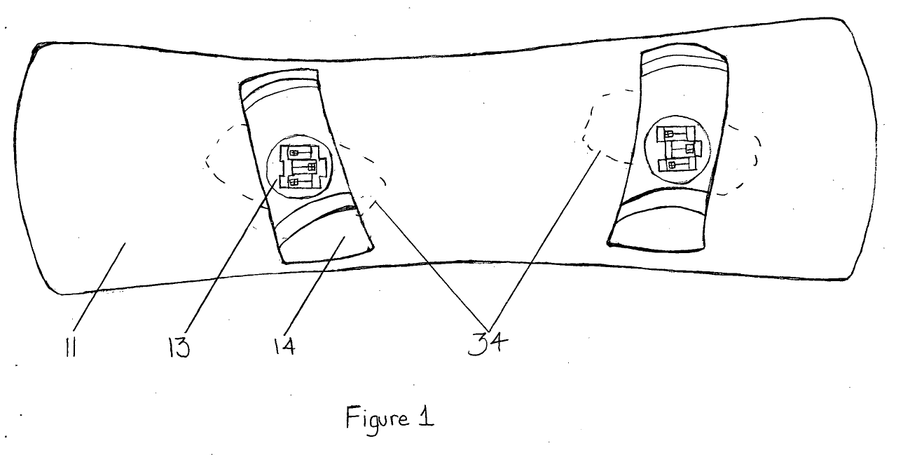

### Preferred Embodiment—FIGS. 1-7

FIG. 1 depicts a snowboard 11 and bindings 14 attached by central baseplates 13. The dotted lines represent an alternative stance 34 a snowboarder may desire.

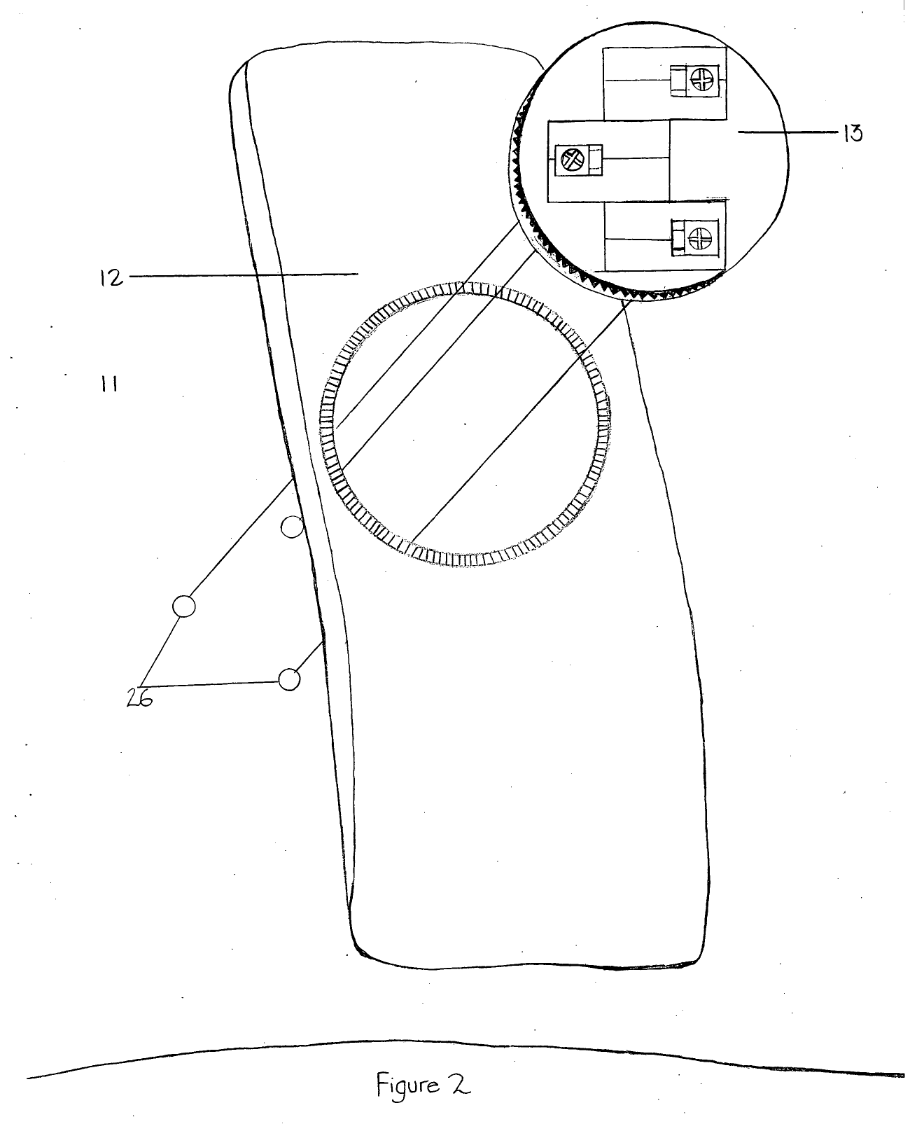

FIG. 2 is a close up and exploded view of the snowboard 11 binding 12 and baseplate 13. The baseplate 13 has an overhanging row of teeth 17, that match and hold down the binding teeth 18. The threads of the snowboard 26 serve as an anchor point.

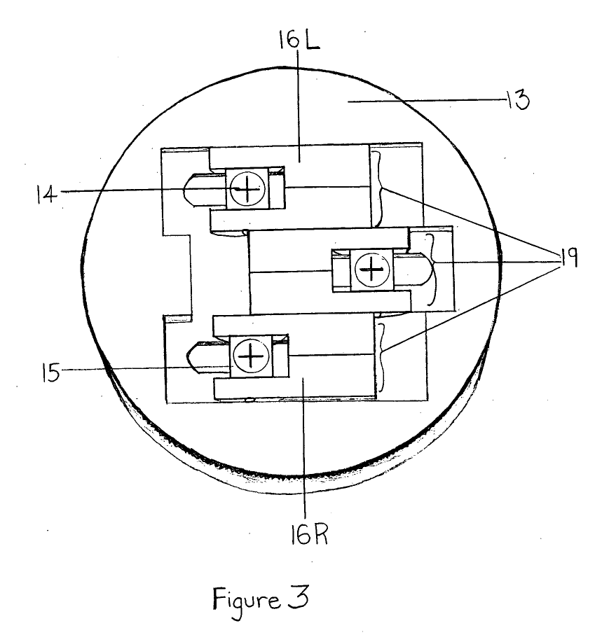

FIG. 3 illustrates a close overhead view of the preferred embodiment of the invention. The invention comprises a baseplate 13, and three lever assemblies 19. Each lever assembly is made up of an anchor screw 14, a pivot piece 15 and two levers 16 L&R. Each anchor screw 14 is engaged by a pivot piece 15. The pivot piece 15 is connected to and sandwiched between two levers 16 L&R.

FIG. 4 is a cross-sectional view of one lever 16R screw 14 and pivot piece 15 in the locked position. Also in cross-sectional view are the baseplate 13, binding apparatus 12, and snowboard 11.

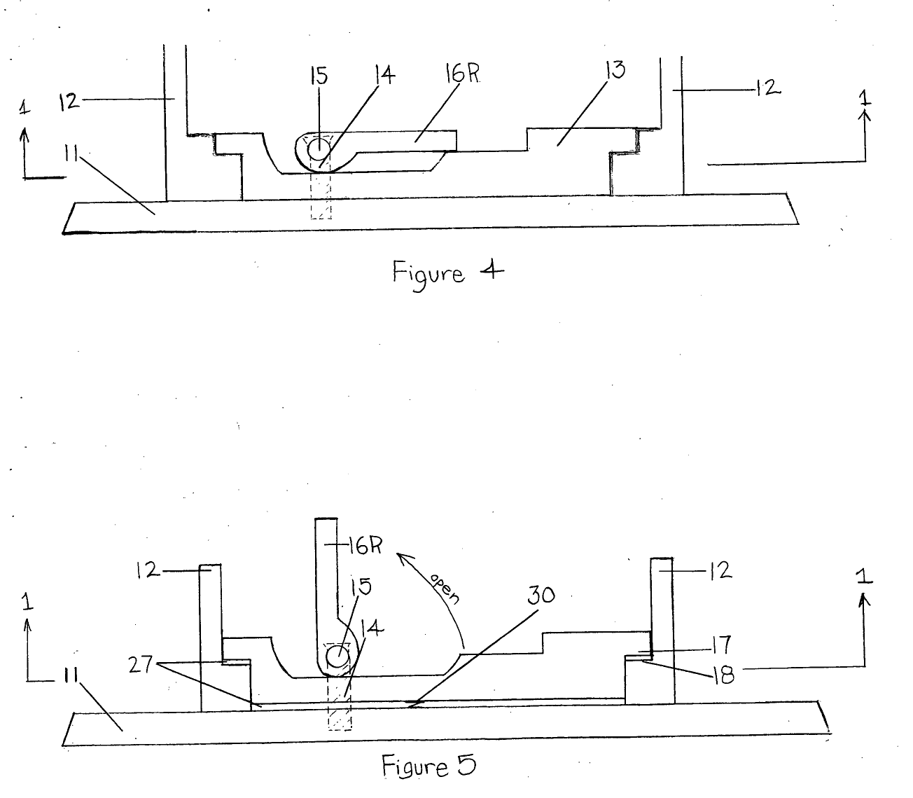

FIG. 5 is the same cross-sectional view, but with the lever 16R in an open position. The screw 14 and pivot piece 15 remain relatively static. The baseplate 13 is separated from the snowboard 11 and bindings 12 by force from the spring 30. The ensuing slack 27 disengages the gear teeth of the baseplate 17 from the corresponding gear teeth of the bindings 18. However, only one tooth from the baseplate and one tooth from the binding are visible on each side in a cross-sectional view.

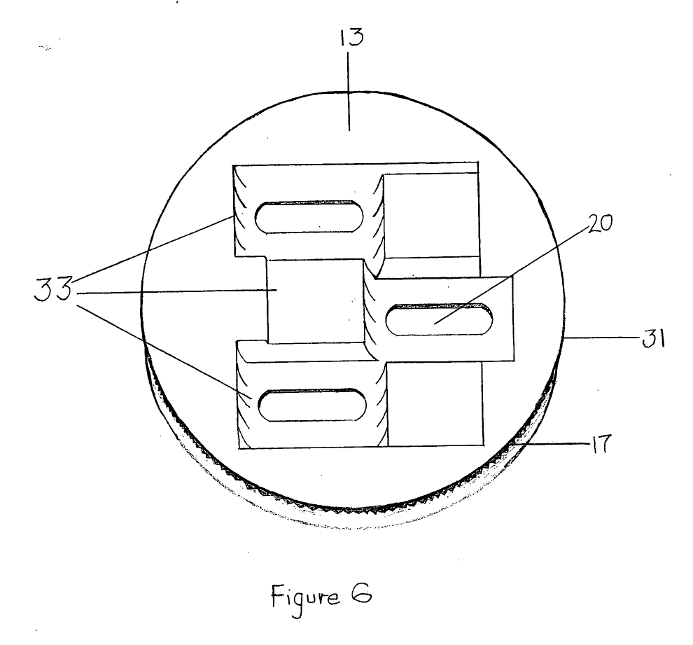

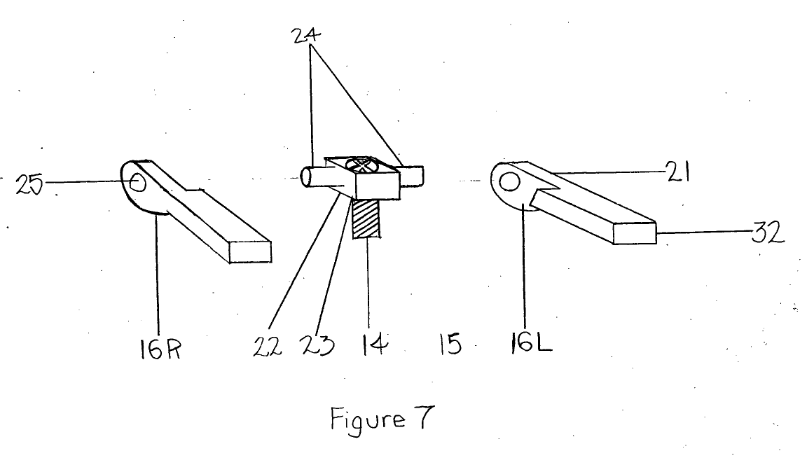

FIG. 6 depicts the baseplate 13 only. It is a round, rigid disc with a non-uniform cross section. The upper diameter of the baseplate is larger than the lower, creating roof-like overhang 31. The overhang 31 exists all along the upper circumference of the baseplate 13. Along the underside of the overhang are the gear teeth 17. Portions of the top of the baseplate 13 have been removed, leaving a varied landscape within. The baseplate 13 has three rectangular trenches 33, of various depths, cut into its top. At the bottom of each trench is a slot 20 that extends clean through the bottom of the baseplate 13. The hollowing out of the baseplate 13 allows for the three lever assemblies to sit recessed inside.

FIG. 7 depicts an exploded view of an individual lever assembly. The levers 16 L&R are in the locked position. Each is made up of a left lever 16L and right lever 16R, along with a pivot piece 15 in between. The screw 14 is housed in the pivot piece 15. The levers, 16 L&R, are inverses of each other, but have the same dimensions. In order to mesh on both sides of the pivot piece 15, the levers are side specific. Both levers, 16 L&R, have a semi-circular end 21, and a handle end 32. The handle end 32 is double the width than the semi-circular end 21. Drilled transversely through each semicircular end 21 is a hole that allows the levers 16 L&R to dock and pivot around the pivot piece 15.

In its preferred embodiment, the pivot piece is a square block 22 with a circular hole 23 drilled through to house the screw. On opposite sides of the block 22 are cylindrical ears 24. In the preferred embodiment, the baseplate, levers, and pivot piece are rigid metals or composites, but can be any other material with a high strength to weight ratio.

### Operation

### Preferred Embodiment—FIGS. 4 & 5

FIG. 4 depicts a side view of one lever assembly 19, baseplate 13, binding 12, and snowboard 11. The lever assembly 19 is in the locked position. Each of the lever assemblies operates in an identical manner.

Correct setup for binding systems that use a baseplate require a tight and secure interface between the baseplate 13, bindings 12, and snowboard 11. The interlocking teeth 17 of the baseplate 13 must be held snug against the teeth 18 of the bindings 12. Adjustment of the bindings 12 is accomplished when one loosens the fit of the system enough to allow the baseplate teeth 17 to become vertically disengaged from the binding teeth 18.

In the present invention, the anchor screws 14 and the pivot piece 15 need only to be adjusted initially, during installation. The anchor screws and their force are connected to the cam levers 16 L&R by the pivot piece 15.

FIG. 5 shows the unlocked state of the invention, when adjustments can be made. When adjustment is desired, one lifts all of the levers 16 L&R to a vertical position. A vertical space or slack 27 is created by loosening the levers 16 L&R. A spring 30 placed under the baseplate 13 employs the slack and moves the baseplate 13 up away from the snowboard 11. This movement disengages the baseplate teeth 17 from the binding teeth 18.

Once unlocked, the bindings 12 enjoy the clearance to adjust rotational position, 360 degrees in both directions, with respect to the snowboard 11. Also, when unlocked, the baseplate 13 is free to adjust longitudinally, with respect to the snowboard 11.

Once the desired stance has been found, one must return all levers 16 L&R, to the locked position. This operation is the opposite of the unlocking process. To lock, one pushes all cam levers 16 L&R down to horizontal, within the baseplate. Locking the cam levers 16 L&R will take more force than unlocking.

Although integral, the pivot piece 15 and the screw 14 do not dramatically change position during operation.

The present invention is compatible with existing manufacturer's stock bindings. One need only purchase the invention, rather than purchasing expensive boot bindings in addition. Further, all integral parts are sheltered from direct and constant contact with snow, helping to avoid jamming. Although the invention is covered by the rider's boot when in motion, access to adjustability is not an issue. Modern chair lift requirement at ski and snowboard resorts mandate a snowboarder remove their rear foot from the boot bindings before use. Therefore, one can change angles and location of stance before the next snowboard descent, which is more practical than during the descent.

What is claimed is:

1. A snowboard boot binding baseplate, adjustable without tools, in both a rotational and fore and aft capacity comprising:
a. a partially hollowed out interior of said baseplate to allow for the contiguous recession of a plurality of lever driven cam locks;
b. said adjustable baseplate with all integral components interior to said adjustable baseplate and said boot binding;
c. said adjustable baseplate does not need to increase the ride height of said boot bindings.
d. said adjustable baseplate can be reconfigured dimensionally to fit the stock boot bindings from various manufacturers;
e. said cam locks each are connected by an anchor screw to said snowboard.
